(19) United States
(12) Patent Application Publication
(10) Pub. No.: US 2019/0286131 A1
(43) Pub. Date: Sep. 19, 2019

(54) ON-BOARD DEVICE, CONTROL RIGHT MANAGEMENT METHOD, AND COMPUTER READABLE MEDIUM

(71) Applicant: MITSUBISHI ELECTRIC CORPORATION, Tokyo (JP)

(72) Inventors: Mikio SASAKI, Tokyo (JP); Mengxiong WANG, Tokyo (JP)

(73) Assignee: MITSUBISHI ELECTRIC CORPORATION, Tokyo (JP)

(21) Appl. No.: 16/318,344

(22) PCT Filed: Jul. 27, 2016
(86) PCT No.: PCT/JP2016/072004

§ 371 Date: Jan. 16, 2019

(51) Int. Cl. G05D 1/00; B60K 35/00

(52) U.S. Cl. CPC G05D 1/0061; B60K 2370/733; B60K 35/00

(57) ABSTRACT

An on-board device (100) is installed on a vehicle (1) in which an automated driving system (300) is installed. A request acquisition unit (111) acquires a transfer request requesting transfer of a control right that is a right to control the automated driving system (300), from any passenger among a plurality of passengers riding in the vehicle (1). A control right management unit (112) determines presence or absence of a driving qualification of a transfer requester who is the requesting passenger of the transfer request and decides whether the control right is to be transferred to the transfer requester or not, based on the presence or absence of the driving qualification of the transfer requester.

### TECHNICAL FIELD

The present invention relates to an on-board device, a control right management method, and a control right management program.

### BACKGROUND ART

In recent years, with progress in technology for automated driving, vehicles that enable the automated driving have been being implemented. Such vehicles that enable the automated driving are capable of arriving at destinations with use of automated driving systems without operation of steering wheels or the like by drivers.

Patent Literature 1 discloses a technique that enables switching between an automated driving mode and a manual driving mode by a select switch.

### CITATION LIST

### Patent Literature

Patent Literature 1: WO 2015/011866

### SUMMARY OF INVENTION

### Technical Problem

Even when the vehicle that enables the automated driving travels in the automated driving mode, operations such as change in a travel route, change in the destination, change in a traveling speed, and designation of a parking lot are required. In addition, sound input or gesture input for operations related to navigation may be required.

Such operations or input may be carried out by not only a passenger who sits in a driver's seat but also passengers who sit in seats other than the driver's seat. That is, it is desirable that a control right which is a right to control the automated driving system is given not only to the passenger who sits in the driver's seat but also to the passengers who sit in the seats other than the driver's seat.

On the other hand, if the control right to the automated driving system is given to a passenger who may exert dangerous control over the automated driving system, there is a possibility that safe traveling may be inhibited.

The present invention mainly aims at enabling transfer of control right to an automated driving system among a plurality of passengers in a vehicle and preventing the transfer of the control right from inhibiting safe traveling.

### Solution to Problem

An on-board device according to the present invention, installed on a vehicle in which an automated driving system is installed, the on-board device includes:

a request acquisition unit to acquire a transfer request requesting transfer of a control right that is a right to control the automated driving system, from any passenger among a plurality of passengers riding in the vehicle; and

a control right management unit to determine presence or absence of a driving qualification of a transfer requester who is the requesting passenger of the transfer request and to decide whether the control right is to be transferred to the transfer requester or not, based on the presence or absence of the driving qualification of the transfer requester.

### Advantageous Effects of Invention

In the present invention, the presence or absence of the driving qualification of the transfer requester is determined and whether the control right is to be transferred to the transfer requester or not is determined based on the presence or absence of the driving qualification of the transfer requester. According to the present invention, consequently, it is possible to transfer the control right among a plurality of passengers in the vehicle and to prevent the transfer of the control right from inhibiting safe traveling.

### BRIEF DESCRIPTION OF DRAWINGS

FIG. 1 is a diagram illustrating a functional configuration example of an on-board system according to Embodiment 1.

FIG. 2 is a flowchart illustrating an example of operations of an on-board device according to Embodiment 1.

FIG. 3 is a flowchart illustrating an example of operations of the on-board device according to Embodiment 1.

FIG. 4 is a flowchart illustrating an example of operations of an on-board device according to Embodiment 2.

FIG. 5 is a diagram illustrating examples of display screens according to Embodiment 1.

FIG. 6 is a diagram illustrating an example of a display screen according to Embodiment 1.

FIG. 7 is a diagram illustrating a hardware configuration example of the on-board device according to Embodiment 1.

### DESCRIPTION OF EMBODIMENTS

Hereinbelow, embodiments of the present invention will be described with use of the drawings. In following description and the drawings on the embodiments, elements provided with identical reference characters represent identical elements or corresponding elements.

### Embodiment 1

***Description on Configurations***

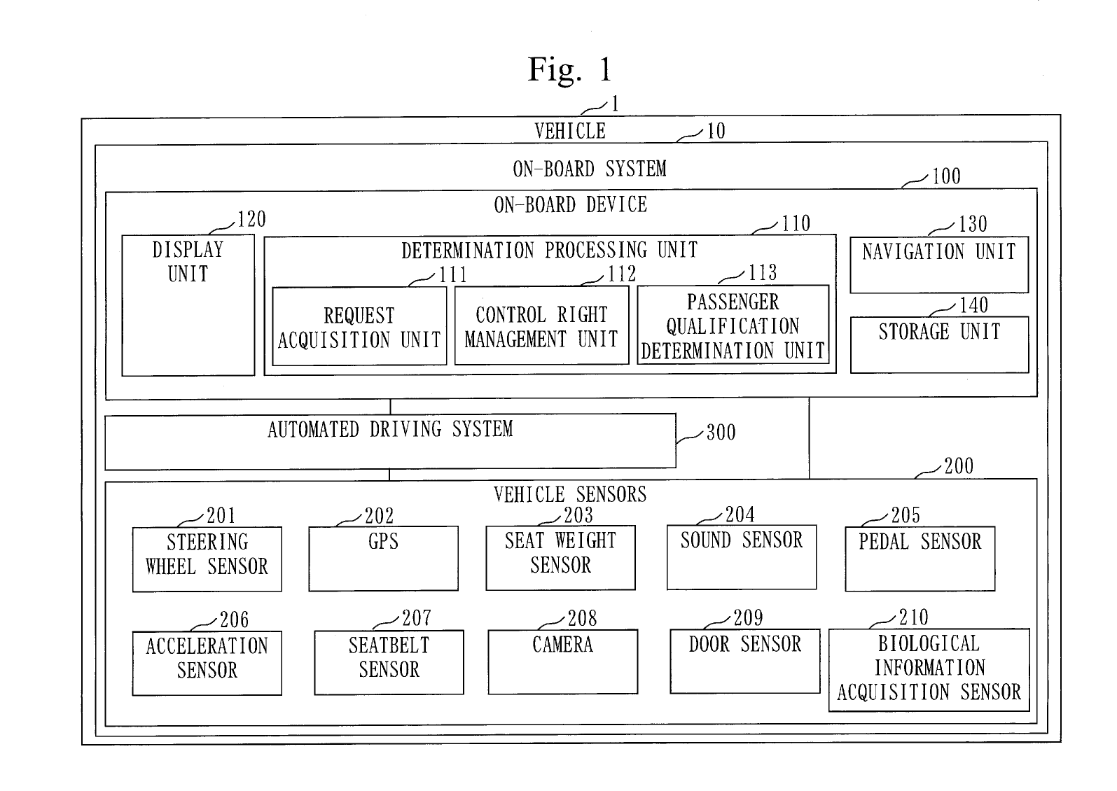

FIG. 1 illustrates a functional configuration example of an on-board system 10 according to the present embodiment.

The on-board system 10 is installed in a vehicle 1.

The on-board system 10 is composed of an on-board device 100, vehicle sensors 200, and an automated driving system 300. Though elements other than the on-board device 100, the vehicle sensors 200, and the automated driving system 300 are also installed as the on-board system 100 in the vehicle 1, in fact, only the on-board device 100, the vehicle sensors 200, and the automated driving system 300 that directly relate to the present embodiment are illustrated in FIG. 1.

The automated driving system 300 implements automated driving.

The vehicle sensors 200 are composed of a plurality of sensors that sense a state of the vehicle 1. In FIG. 1, as an example, the vehicle sensors 200 are composed of a steering wheel sensor 201, a GPS 202, a seat weight sensor 203, a sound sensor 204, a pedal sensor 205, an acceleration sensor 206, a seatbelt sensor 207, a camera 208, a door sensor 209, and a biological information acquisition sensor 210.

The on-board device 100 carries out navigation and manages the control right to the automated driving system 300. The control right to the automated driving system 300 includes a right to make switching from an automated driving mode to a manual driving mode, a right to change a traveling speed, a right to change a travel route, a right to change a destination, a right to designate a parking lot, and the like.

Operations that are carried out by the on-board device 100 are equivalent to the control right management method. Details of components of the on-board device 100 will be described later.

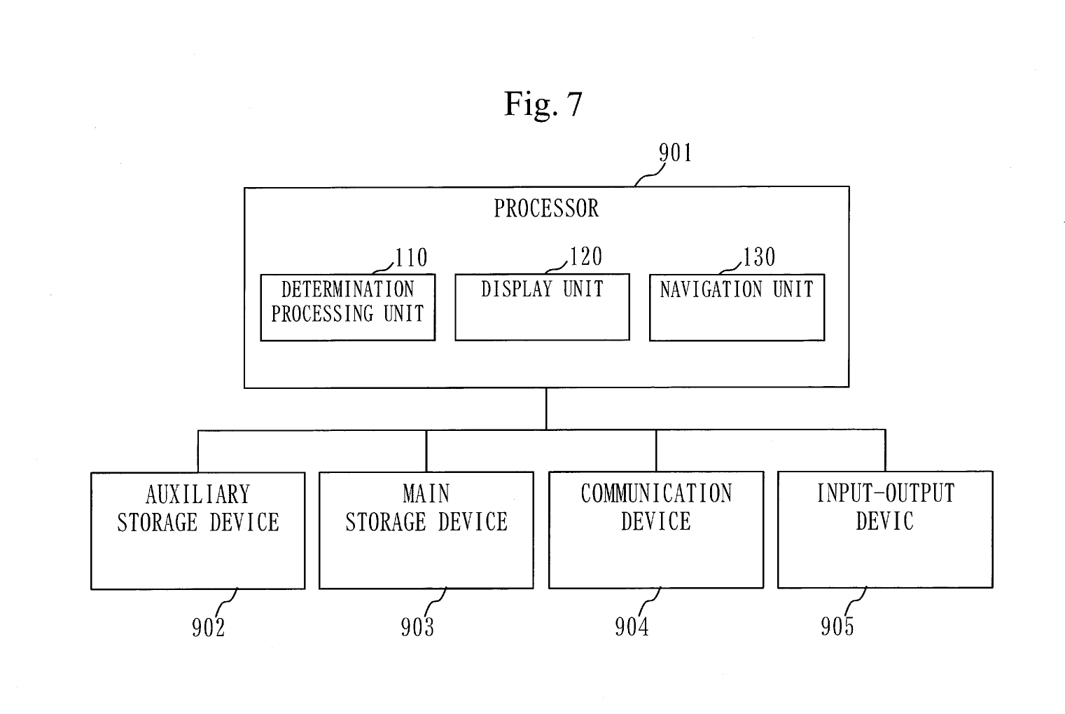

FIG. 7 illustrates a hardware configuration example of the on-board device 100.

The on-board device 100 is a computer.

The on-board device 100 includes a processor 901, an auxiliary storage device 902, a main storage device 903, a communication device 904, and an input-output device 905, as hardware.

Programs that fulfil functions of a determination processing unit 110, a display unit 120, and a navigation unit 130 that are illustrated in FIG. 1 are stored in the auxiliary storage device 902.

The programs are loaded from the auxiliary storage device 902 into the main storage device 903. By executing the programs, the processor 901 carries out operations of the determination processing unit 110, the display unit 120, and the navigation unit 130 that will be described later.

FIG. 7 schematically represents a state in which the processor 901 executes the programs that fulfil the functions of the determination processing unit 110, the display unit 120, and the navigation unit 130.

The program that fulfils the functions of the determination processing unit 110 is equivalent to the control right management program.

The communication device 904 is a circuit that communicates with the vehicle sensors 200, for instance.

The input-output device 905 is a display compatible with a touch panel, for instance. In the present embodiment, it is assumed that the display is installed for each of a plurality of seats included in the vehicle 1.

Subsequently, a functional configuration of the on-board device 100 illustrated in FIG. 1 will be described.

In the determination processing unit 110, a request acquisition unit 111 acquires a request from a passenger in the vehicle 1.

Specifically, the request acquisition unit 111 acquires a transfer request that requests transfer of the control right, from any passenger among a plurality of passengers who ride in the vehicle 1. Upon acquisition of the transfer request, the request acquisition unit 111 identifies a seat from which the transfer request is issued, as a requesting seat.

The request acquisition unit 111 may acquire a renunciation request that requests renunciation of the control right, from a control right holder. The control right holder is a passenger who currently holds the control right.

A process that is carried out by the request acquisition unit 111 is equivalent to the request acquisition process.

When the request acquisition unit 111 acquires the transfer request, a control right management unit 112 determines presence or absence of a driving qualification of a transfer requester, based on presence or absence of the driving qualification that is made to correspond to the requesting seat in seat passenger information stored in a storage unit 140 which will be described later. The transfer requester is a requesting passenger who requests the transfer request. The driving qualification is a qualification to duly drive the vehicle 1. If a passenger holds a driver's license which permits driving the vehicle 1 and carries the driver's license, the passenger has the driving qualification. However, if the passenger is under influence of liquor, the passenger does not have the driving qualification.

In case where the transfer requester has the driving qualification, the control right management unit 112 inquires of the control right holder whether the control right holder consents to the transfer of the control right to the transfer requester or not and determines whether to transfer the control right to the transfer requester or not, based on a response from the control right holder.

When the request acquisition unit 111 acquires the renunciation request from the control right holder, the control right management unit 112 determines whether the request acquisition unit 111 has acquired the transfer request from any passenger other than the control right holder or not. In case where the request acquisition unit 111 has acquired the transfer request from any passenger other than the control right holder when the request acquisition unit 111 acquires the renunciation request from the control right holder, the control right management unit 112 determines whether to transfer the control right to the requesting passenger who requests the transfer request or not. Upon determination that the control right is to be transferred to the transfer requester, the control right management unit 112 switches a display screen, displayed on the display for the seat in which the transfer requester sits, into a display screen for the control right holder.

On the other hand, in case where the request acquisition unit 111 has not acquired the transfer request from any passenger other than the control right holder when the request acquisition unit 111 acquires the renunciation request from the control right holder, the control right management unit 112 makes the control right holder remain holding the control right and switches the display screen on the display installed for a seat in which the control right holder sits, from the display screen for the control right holder to another display screen.

The control right management unit 112 may change a layout of the display screen for the control right holder in accordance with a position of the seat.

A process that is carried out by the control right management unit 112 is equivalent to the control right management process.

A passenger qualification determination unit 113 determines presence or absence of the driving qualification of the passenger who sits in each seat among the plurality of seats included in the vehicle 1, before the vehicle 1 starts to travel. The passenger qualification determination unit 113 generates the seat passenger information based on results of determination and stores the generated seat passenger information in the storage unit 140. In the seat passenger information, the seats and the presence or absence of the driving qualification of the passengers who sit in the seats are represented so as to correspond to each other.

In case where any of the passengers does not have the driving qualification, the passenger qualification determination unit 113 warns that the vehicle 1 is prohibited from traveling.

Details of operations of the passenger qualification determination unit 113 will be described in Embodiment 2.

The display unit 120 displays a display screen on the display installed for each seat.

The navigation unit 130 carries out car navigation.

The storage unit 140 stores the seat passenger information generated by the passenger qualification determination unit 113.

The storage unit 140 also stores control right holder seat information. The seat of the control right holder is described in the control right holder seat information.

The storage unit 140 further stores presence or absence of the transfer request, the seat of the transfer requester, presence or absence of the renunciation request, and the like.

The storage unit 140 is implemented by the auxiliary storage device 902 and/or the main storage device 903 that are illustrated in FIG. 7.

***Description on Operations***

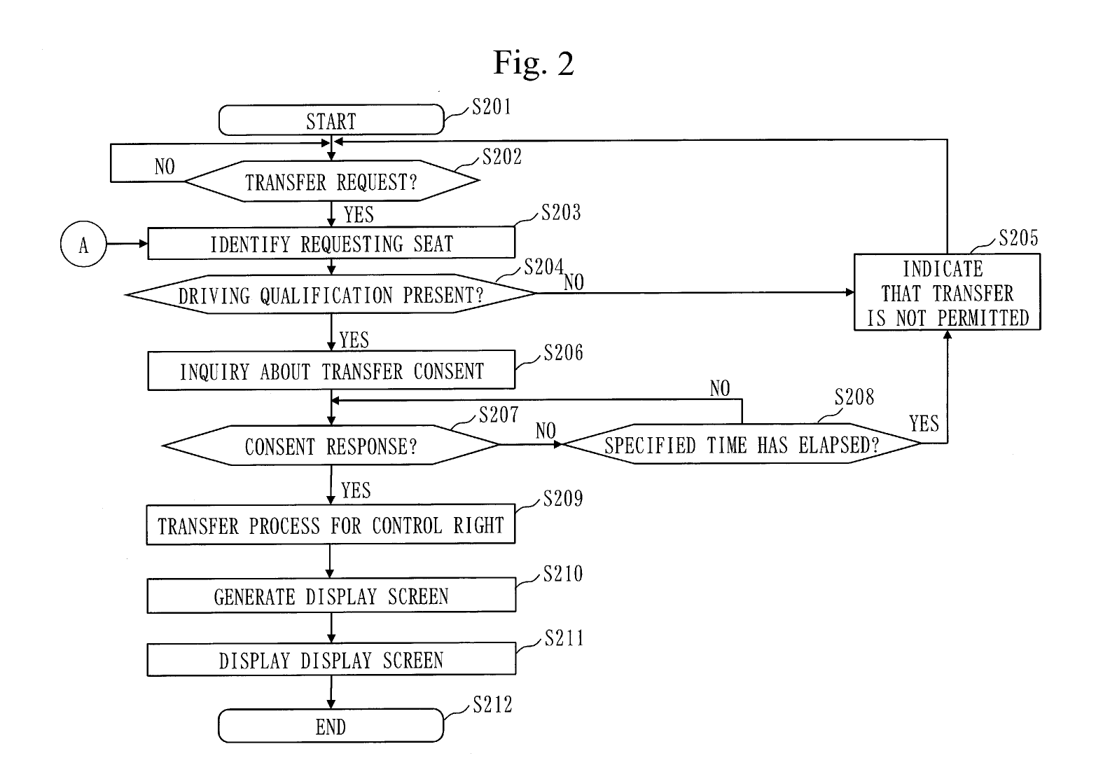

Subsequently, an example of operations of the on-board device 100 according to the present embodiment will be described with reference to a flowchart of FIG. 2.

A processing procedure illustrated in FIG. 2 is carried out in a state in which a plurality of passengers ride in the vehicle 1 and in which the vehicle 1 is traveling under the automated driving by the automated driving system 300. It is assumed that the seat passenger information has been already stored in the storage unit 140 when the processing procedure of FIG. 2 is carried out.

When the request acquisition unit 111 acquires the transfer request from any of the passengers (YES in step S202), the request acquisition unit 111 stores the transfer request in the storage unit 140.

A passenger may transmit the transfer request to the request acquisition unit 111 by pressing a specified button in the display screen displayed on the display installed for the seat, for instance. A passenger may issue the transfer request with use of a sound. In this case, the sound sensor 204 receives the transfer request of the sound from the passenger and the sound sensor 204 transmits the transfer request to the request acquisition unit 111.

Subsequently, the request acquisition unit 111 identifies the requesting seat that is the seat in which the passenger having transmitted the transfer request (transfer requester) sits (step S203).

Specifically, the request acquisition unit 111 identifies the requesting seat by identifying the display of a source of the transfer request. In case where the transfer request has been made of the sound, the sound sensor 204 transmits, to the request acquisition unit 111, the transfer request along with a seat ID (Identifier) of the seat from which the sound has been emitted. Therefore, the request acquisition unit 111 may identify the requesting seat based on the seat ID.

The request acquisition unit 111 notifies the control right management unit 112 of the identified requesting seat.

Subsequently, the control right management unit 112 refers to the seat passenger information and thereby determines the presence or absence of the driving qualification of the transfer requester (step S204).

In case where it is stated in the seat passenger information that the driving qualification is “present” in relation to the requesting seat, the control right management unit 112 determines that the transfer requester has the driving qualification. On the other hand, in case where it is stated in the seat passenger information that the driving qualification is “absent” in relation to the requesting seat, the control right management unit 112 determines that the transfer requester does not have the driving qualification.

In case where the transfer requester does not have the driving qualification (NO in step S204), the control right management unit 112 indicates, to the transfer requester, that the transfer of the control right is not permitted (step S205).

For instance, the control right management unit 112 displays a message that the transfer of the control right is not permitted, on the display installed for the seat of the transfer requester, through the display unit 120. The control right management unit 112 may notify the transfer requester of the message that the transfer of the control right is not permitted, with use of a sound.

On the other hand, in case where the transfer requester has the driving qualification (YES in step S204), the control right management unit 112 inquires of the control right holder whether the control right holder consents to the transfer of the control right to the transfer requester or not (step S206).

For instance, the control right management unit 112 displays a message that inquires whether to consent to the transfer of the control right or not, on the display installed for the seat of the control right holder, through the display unit 120. The control right management unit 112 reads out the control right holder seat information from the storage unit 140 and displays the message on the display installed for the seat of the control right holder. The control right management unit 112 may notify the control right holder of the message that inquires whether to consent to the control right or not, with use of a sound.

Subsequently, the control right management unit 112 determines whether a consent response from the control right holder has been acquired or not (step S207).

When the control right holder consents to the transfer of the control right to the transfer requester in response to an inquiry of step S206, the control right holder issues the consent response. The control right holder may transmit the consent response to the request acquisition unit 111 by pressing a specified button in the display screen displayed on the display installed for the seat, for instance. When the control right holder sits in the driver's seat, the control right holder may transmit the consent response to the control right management unit 112 by releasing hands of the control right holder from a steering wheel, for instance. In this case, release of the hands from the steering wheel sensor 201 is detected and the steering wheel sensor 201 transmits a signal for notification of the release of the hands from the steering wheel to the control right management unit 112.

In case where the control right management unit 112 acquires the consent response (YES in step S207), a process of step S209 is carried out.

On the other hand, in case where the control right management unit 112 does not acquire the consent response (NO in step S207), a process of step S208 is carried out.

In step S208, the control right management unit 112 determines whether specified time has elapsed or not since the inquiry of step S206.

In case where the specified time has not elapsed (NO in step S208), the control right management unit 112 determines in step S207 whether the consent response has been made or not.

On the other hand, in case where the specified time has elapsed (YES in step S208), it is indicated to the transfer requester in step S205 that the transfer of the control right is not permitted.

In step S209, the control right management unit 112 executes a transfer process for the control right.

That is, the control right management unit 112 notifies the automated driving system 300 of the transfer requester as a new control right holder, through the communication device 904. Thus the automated driving system 300 operates in pursuant to instructions from the new control right holder.

The control right management unit 112 updates the control right holder seat information recorded in the storage unit 140. That is, the control right management unit 112 rewrites the control right holder seat information into information in which the seat of the new control right holder is described.

Hereinbelow, the passenger who was the control right holder before the transfer of the control right will be referred to as a former control right holder.

Subsequently, the control right management unit 112 generates a display screen that is to be displayed on the display installed for the seat of the new control right holder and a display screen that is to be displayed on the display set up on the seat of the former control right holder (step S210).

That is, the control right management unit 112 generates the display screen for the control right holder as the display screen that is to be displayed on the display installed for the seat of the new control right holder. Besides, the control right management unit 112 generates a display screen for a control right non-holder as the display screen that is to be displayed on the display installed for the seat of the former control right holder.

Through the display unit 120, subsequently, the control right management unit 112 displays the display screen for the control right holder on the display installed for the seat of the new control right holder and displays the display screen for the control right non-holder on the display set up on the seat of the former control right holder (step S211).

In relation to step S210, the control right management unit 112 may vary the display screen for the control right holder in accordance with the seat of the new control right holder.

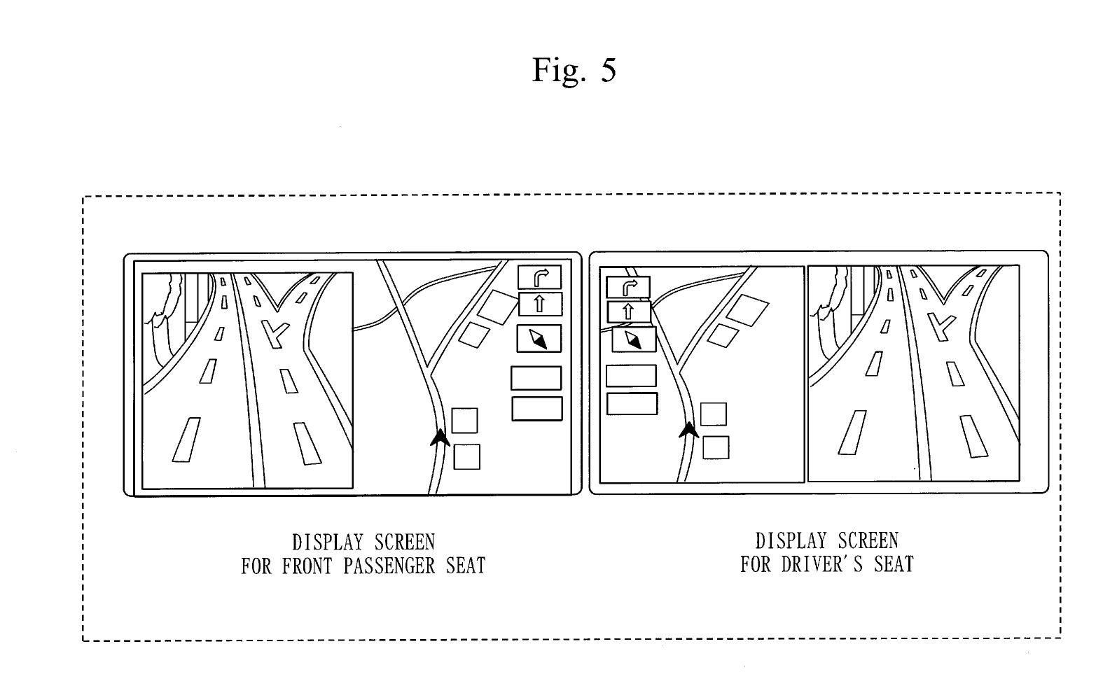

FIG. 5 illustrates an example of the display screen for the control right holder in the driver's seat and an example of the display screen for the control right holder in a front passenger seat.

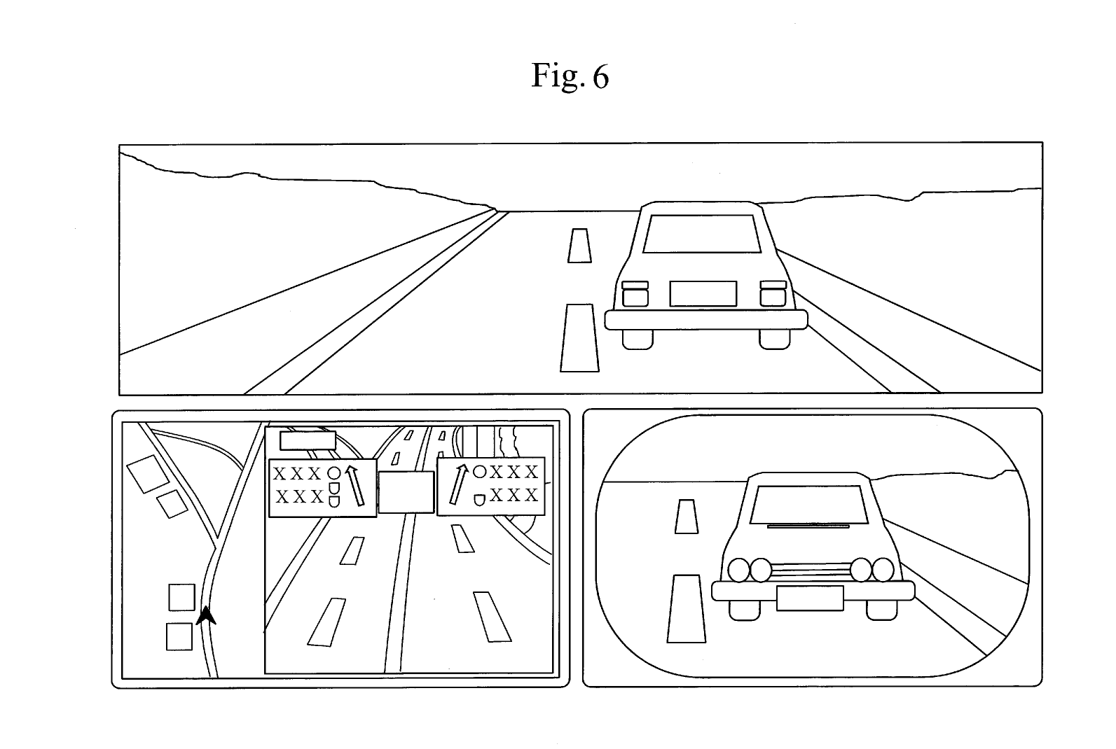

FIG. 6 illustrates an example of the display screen for the control right holder in a rear seat.

On the display screen for the control right holder in the driver's seat in FIG. 5, a navigation image is displayed on a right side and map information is displayed on a left side. In addition, various operation buttons are displayed along a left end.

On the display screen for the control right holder in the front passenger seat, a navigation image is displayed on the left side and the map information is displayed on the right side. In addition, the various operation buttons are displayed along a right end.

On the display screen for the control right holder in the rear seat in FIG. 6, real-time video in a frontward view and a rearward view from the vehicle 1, shot by the camera 208, a navigation image, and the map information are displayed.

The control right management unit 112 may vary the display screen for the control right holder, for each passenger and each seat.

That is, the control right management unit 112 displays a display screen X-1 for the control right holder in the driver's seat when the control right holder is a passenger X sitting in the driver's seat, for instance. When the control right holder is the passenger X sitting in the front passenger seat, the control right management unit 112 displays a display screen X-2 for the control right holder in the front passenger seat. When the control right holder is a passenger Y sitting in the driver's seat, similarly, the control right management unit 112 displays a display screen Y-1 for the control right holder in the driver's seat. When the control right holder is the passenger Y sitting in the front passenger seat, the control right management unit 112 displays a display screen Y-2 for the control right holder in the front passenger seat.

The control right holder may transmit the renunciation request by which the renunciation of the control right is requested. The control right holder may transmit the renunciation request to the request acquisition unit 111 by pressing a specified button in the display screen displayed on the display installed for the seat, for instance. When the control right holder sits in the driver's seat, the control right holder may transmit the renunciation request to the request acquisition unit 111 by releasing the hands of the control right holder from the steering wheel, for instance. Furthermore, the control right holder may transmit the renunciation request to the request acquisition unit 111 with use of a sound.

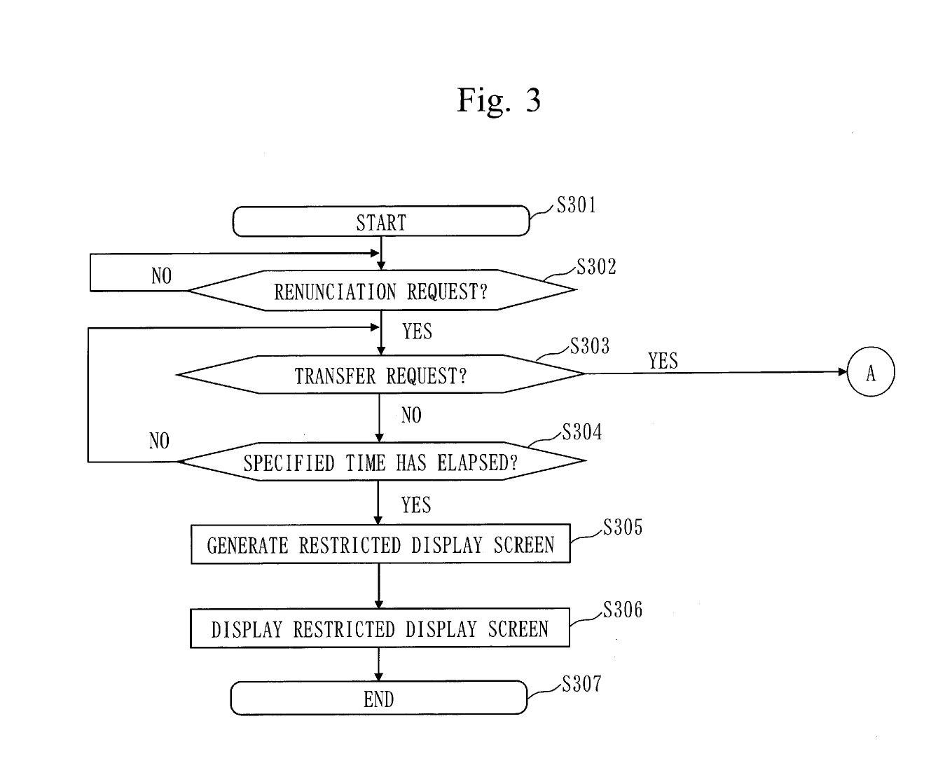

Hereinbelow, with reference to FIG. 3, an example of operations of the on-board device 100 upon transmission of the renunciation request from the control right holder will be described.

In the on-board device 100, when the request acquisition unit 111 acquires the renunciation request (YES in step S302), the control right management unit 112 determines whether the request acquisition unit 111 has acquired the transfer request from any passenger other than the control right holder or not (step S303).

In case where the request acquisition unit 111 has not received the transfer request, the control right management unit 112 determines whether specified time has elapsed or not since acquisition of the renunciation request in step S302 (step S304).

Then the control right management unit 112 may display a message that invites to be a transferee of the control right, on the displays on the seats of the passengers other than the control right holder. The control right management unit 112 may notify the passengers other than the control right holder of the message that invites to be the transferee of the control right, with use of a sound.

In case where the request acquisition unit 111 has not received the transfer request after the specified time has elapsed (YES in step S304), the control right is not transferred but the control right management unit 112 generates a restricted display screen because the control right holder does not want to control the automated driving system (step S305). On the restricted display screen, information presentation to the control right holder is restricted to minimum information such as danger warning and arrival at the destination.

Subsequently, the control right management unit 112 displays the restricted display screen on the display installed for the seat of the control right holder, through the display unit 120 (step S306).

Then the control right is not transferred and thus the control right holder may resume the control over the automated driving system 300.

On the other hand, in case of YES in step S303, that is, in case where the request acquisition unit 111 has acquired the transfer request from any passenger other than the control right holder, operations of step S203 and later in FIG. 2 are carried out.

That is, the control right management unit 112 determines whether the control right is to be transferred to the transfer requester or not, based on the presence or absence of the driving qualification of the transfer requester and presence or absence of transfer consent of the control right holder.

***Description on Effects of Embodiment***

In the present embodiment, the presence or absence of the driving qualification of the transfer requester is decided and whether the control right is to be transferred to the transfer requester or not is determined based on the presence or absence of the driving qualification of the transfer requester. Therefore, the control right is not transferred to a passenger who does not have the driving qualification and who may exert dangerous control over the automated driving system. According to the present embodiment, consequently, it is possible to transfer the control right among a plurality of passengers in the vehicle and to prevent the transfer of the control from inhibiting safe traveling.

### Embodiment 2

When a plurality of persons simultaneously ride in the vehicle 1, it is necessary to decide an initial control right holder. In Embodiment 2, a procedure through which the passenger qualification determination unit 113 decides the initial control right holder when the passengers ride in the vehicle 1 will be described.

***Description on Configurations***

The functional configuration example of the on-board system 10 is as illustrated in FIG. 1. The hardware configuration example of the on-board device 100 is as illustrated in FIG. 7.

In the present embodiment, differences from Embodiment 1 will be principally described.

Matters that will not be described in the present embodiment are similar to those of Embodiment 1.

***Description on Operations***

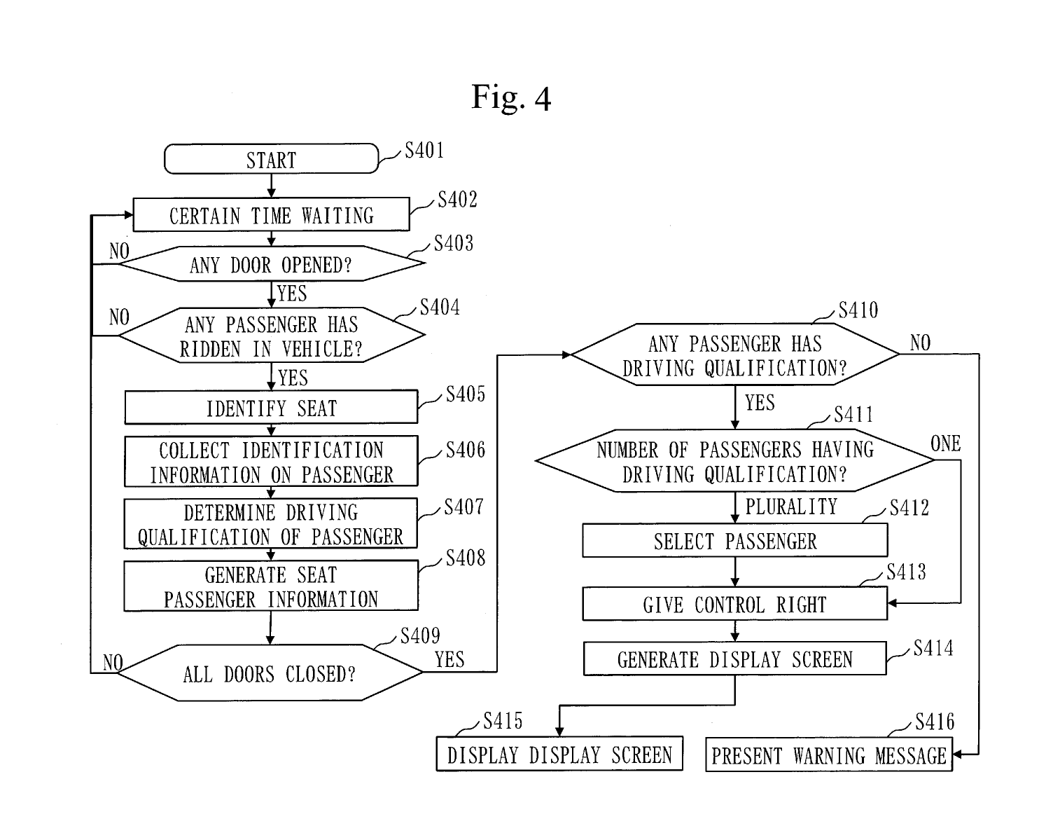

FIG. 4 illustrates an example of operations of the on-board device 100 according to the present embodiment.

The door sensor 209 periodically monitors opening and closing of all doors of the vehicle 1 (step S402).

When the door sensor 209 detects the opening of any of the doors (YES in step S403), the door sensor 209 transmits, to the passenger qualification determination unit 113, a door opening detection signal that is notification of the opening of the door.

Upon reception of the door opening detection signal from the door sensor 209, the passenger qualification determination unit 113 determines whether any passenger has ridden in the vehicle or not (step S404).

The seat weight sensor 203 provided on each seat in the vehicle transmits, to the passenger qualification determination unit 113, a ride detection signal that is notification of a ride of a passenger in the vehicle when a load is applied onto the seat. The passenger qualification determination unit 113 determines that the passenger has ridden in the vehicle, upon reception of the ride detection signal from the seat weight sensor 203.

When any passenger rides in the vehicle (YES in step S404), the passenger qualification determination unit 113 identifies a seat in which the passenger sits (step S405).

The seat weight sensor 203 includes the seat ID of the seat in which the seat weight sensor 203 is provided, in the ride detection signal, and transmits the ride detection signal to the passenger qualification determination unit 113, for instance. The passenger qualification determination unit 113 identifies the seat in which the passenger sits, based on the seat ID included in the received ride detection signal.

The passenger qualification determination unit 113 may identify the seat in which the passenger sits, by receiving a seatbelt wearing detection signal for notification of detection of wearing of a seatbelt from the seatbelt sensor 207.

The passenger qualification determination unit 113 may identify the seat in which the passenger sits, based on power-on of or a touch on the display installed for the seat by the passenger.

Subsequently, the passenger qualification determination unit 113 collects identification information on the passenger (step S406).

For instance, the passenger qualification determination unit 113 acquires a facial image of the passenger, as the identification information, by the camera 208. The passenger qualification determination unit 113 acquires biological information on veins, a fingerprint, or the like of the passenger, as the identification information, by the biological information acquisition sensor 210.

Subsequently, the passenger qualification determination unit 113 determines whether each passenger has the driving qualification or not (step S407).

For instance, the passenger qualification determination unit 113 transmits the identification information on the passenger acquired in step S406, with use of the communication device 904, to a database in which the identification information and presence or absence of the driver's license are registered. The passenger qualification determination unit 113 determines whether the passenger holds the driver's license or not, in accordance with a response from the database. The database described above may be a database in the vehicle or a database out of the vehicle.

Moreover, the passenger qualification determination unit 113 determines whether the passenger carries the driver's license or not, by making the camera 208 take a picture of the driver's license of the passenger.

The passenger qualification determination unit 113 may determine whether the passenger is under influence of liquor or not, with use of an odor sensor not illustrated in FIG. 1, for instance.

On condition that a passenger holds a driver's license that permits driving the vehicle 1 and carries the driver's license, the passenger has the driving qualification. On condition that the passenger is under the influence of liquor, however, the passenger does not have the driving qualification.

Subsequently, the passenger qualification determination unit 113 generates the seat passenger information (step S408). In the seat passenger information, the seats and the presence or absence of the driving qualification of the passengers who sit in the seats are represented so as to correspond to each other.

The passenger qualification determination unit 113 stores the generated seat passenger information in the storage unit 140.

Subsequently, the passenger qualification determination unit 113 determines whether all the doors of the vehicle 1 are closed or not (step S409).

Specifically, the passenger qualification determination unit 113 determines that all the doors of the vehicle 1 are closed, upon reception of door closing detection signals for notification of the closing of the doors from the door sensors 209 of all the doors.

When all the doors of the vehicle 1 are closed (YES in step S409), that is, when all the passengers ride in the vehicle, the passenger qualification determination unit 113 determines whether any passenger who has the driving qualification rides in the vehicle or not (step S410).

Specifically, the passenger qualification determination unit 113 refers to the seat passenger information generated in step S408 and thereby determines whether any passenger who has the driving qualification rides in the vehicle or not.

In case where any of the passengers does not have the driving qualification (NO in step S410), the passenger qualification determination unit 113 presents a warning message warning that the vehicle 1 is prohibited from traveling (step S416).

For instance, the passenger qualification determination unit 113 displays the warning message on the displays on the seats in which the passengers sit. The passenger qualification determination unit 113 may output the warning message with use of a sound.

The passenger qualification determination unit 113 may transmit, to the automated driving system 300, a command that prohibits traveling.

In case where any passenger who has the driving qualification exists (YES in step S410), the passenger qualification determination unit 113 determines whether the number of the passengers who have the driving qualification is one or plurality (step S211).

In case where the number of the passengers who have the driving qualification is one (“ONE” in step S411), the passenger qualification determination unit 113 gives the one passenger the control right to the automated driving system 300 (step S413).

Specifically, the passenger qualification determination unit 113 generates the control right holder seat information in which the seat of the passenger is described.

The passenger qualification determination unit 113 stores the generated control right holder seat information in the storage unit 140.

In case where the number of the passengers who have the driving qualification is plurality (“PLURALITY” in step S411), the passenger qualification determination unit 113 selects the passenger to whom the control right is to be given from among the plurality of passengers (step S412).

The passenger qualification determination unit 113 selects the passenger to whom the control right is to be given, based on the seats of the passengers, for instance. Specifically, when the passenger who sits in the driver's seat exists, the passenger qualification determination unit 113 selects the passenger who sits in the driver's seat.

The passenger qualification determination unit 113 may select an owner of the vehicle 1.

Alternatively, the passenger qualification determination unit 113 may select the passenger who has the longest years of experience in driving.

Subsequently, the passenger qualification determination unit 113 gives the control right to the automated driving system 300, to the passenger selected in step S412 (step S413).

Specifically, the passenger qualification determination unit 113 generates the control right holder seat information in which the seat of the passenger is described.

The passenger qualification determination unit 113 stores the generated control right holder seat information in the storage unit 140.

In step S414, the passenger qualification determination unit 113 generates a display screen corresponding to the seat in which the passenger having the control right given in step S413 sits.

That is, in case where the seat in which the passenger sits is the driver's seat or the front passenger seat, the passenger qualification determination unit 113 generates the display screen illustrated in FIG. 5, for instance. On the other hand, in case where the seat in which the passenger sits is a rear seat, the passenger qualification determination unit 113 generates the display screen illustrated in FIG. 6, for instance.

Finally, the passenger qualification determination unit 113 displays the display screen generated in step S414 on a relevant display (step S415).

***Description on Effects of Embodiment***

According to the embodiment, in case where any of the passengers does not have the driving qualification, the passengers may be dissuaded from making the vehicle travel.

Though the embodiments of the present invention have been described above, a combination of two or more out of the embodiments may be implemented.

Alternatively, one of the embodiments may be partially implemented.

Alternatively, a partial combination of two or more out of the embodiments may be implemented.

The present invention is not limited to the embodiments and various modifications thereto may be made as appropriate.

***Description on Hardware Configuration***

Finally, supplementary description on the hardware configuration of the on-board device 100 will be given.

The processor 901 illustrated in FIG. 7 is an IC (Integrated Circuit) that carries out processing.

The processor 901 is a CPU (Central Processing Unit), a DSP (Digital Signal Processor), or the like.

The main storage device 903 illustrated in FIG. 7 is a RAM (Random Access Memory), for instance.

The auxiliary storage device 902 illustrated in FIG. 7 is a ROM (Read Only Memory), a flash memory, an HDD (Hard Disk Drive), or the like.

The communication device 904 illustrated in FIG. 7 includes a receiver that receives data and a transmitter that transmits data.

The communication device 904 is a communication chip or an NIC (Network Interface Card), for instance.

An OS (Operating System) is also stored in the auxiliary storage device 902.

At least a portion of the OS is executed by the processor 901.

While executing at least the portion of the OS, the processor 901 executes the programs that fulfil the functions of the request acquisition unit 111, the control right management unit 112, and the passenger qualification determination unit 113 (which will be collectively referred to as the “units”, hereinbelow).

The processor 901 executes the OS, so that task management, memory management, file management, communication control, and the like are carried out.

The on-board device 100 may include a plurality of processors that substitute for the processor 901. Execution of the programs that fulfil the functions of the “units” is shared by the plurality of processors. Each of the processors is an IC that carries out processing as with the processor 901.

Information, data, signal values, variable values, and the like that indicate results of processing in the “units” are stored in at least any of the auxiliary storage device 902, the main storage device 903, and a register and a cache memory in the processor 901.

The programs that fulfil the functions of the “units” may be stored in a portable storage medium such as a magnetic disk, a flexible disk, an optical disk, a compact disk, a Blu-ray (a registered trademark) disk, or a DVD.

The “units” may be read as “circuits”, “steps”, “procedures”, or “process”.

The on-board device 100 may be implemented by an electronic circuit such as a logic IC (Integrated Circuit), a GA (Gate Array), an ASIC (Application Specific Integrated Circuit), or an FPGA (Field-Programmable Gate Array).

In this case, the “units” are each implemented as a portion of the electronic circuit.

The processor and the electronic circuit may be collectively referred to as processing circuitry.

### REFERENCE SIGNS LIST

1: vehicle; 10: on-board system; 100: on-board device; 110: determination processing unit; 111: request acquisition unit; 112: control right management unit; 113: passenger qualification determination unit; 120: display unit; 130: navigation unit; 140: storage unit; 200: vehicle sensors; 201: steering wheel sensor; 202: GPS; 203: seat weight sensor; 204: sound sensor; 205: pedal sensor; 206: acceleration sensor; 207: seatbelt sensor; 208: camera; 209: door sensor; 210: biological information acquisition sensor; 300: automated driving system

1-10. (canceled)

11. An on-board device installed on a vehicle in which an automated driving system is installed, the vehicle including a plurality of seats for each of which a display is installed, the on-board device comprising:
processing circuitry to:
acquire a transfer request requesting transfer of a control right that is a right to control the automated driving system, from any passenger among a plurality of passengers riding in the vehicle; and
determine presence or absence of a driving qualification of a transfer requester who is the requesting passenger of the transfer request and to decide whether the control right is to be transferred to the transfer requester or not, based on the presence or absence of the driving qualification of the transfer requester,
wherein the processing circuitry varies a layout of a display screen for a control right holder to be displayed on a display of a seat in which the control right holder sits, the control right holder being a passenger currently holding the control right, in accordance with which passenger among the plurality of passengers is the control right holder and which seat among the plurality of seats is the seat in which the control right holder sits.

12. The on-board device according to claim 11, wherein
the processing circuitry
inquires of the control right holder whether the control right holder consents to the transfer of the control right to the transfer requester or not, and
decides whether the control right is to be transferred to the transfer requester or not, based on a response from the control right holder and the presence or absence of the driving qualification of the transfer requester.

13. The on-board device according to claim 11, further comprising:
a memory to store seat passenger information in which a plurality of seats included in the vehicle and presence or absence of the driving qualification of the passengers who sit in the seats are represented so as to correspond to each other, wherein
the processing circuitry identifies a seat from which the transfer request is issued, as a requesting seat, upon acquisition of the transfer request, and
determines the presence or absence of the driving qualification of the transfer requester, based on presence or absence of the driving qualification corresponding to the requesting seat in the seat passenger information.

14. The on-board device according to claim 12, wherein
the processing circuitry acquires a renunciation request requesting renunciation of the control right, from the control right holder,
determines whether the transfer request has been acquired from any passenger other than the control right holder or not, upon acquisition of the renunciation request from the control right holder, and
decides whether the control right is to be transferred to the requesting passenger of the transfer request or not, in case where the transfer request has been acquired from any passenger other than the control right holder upon the acquisition of the renunciation request from the control right holder.

15. The on-board device according to claim 11, wherein
the processing circuitry acquires a renunciation request requesting renunciation of the control right, from the control right holder,
determines whether the transfer request has been acquired from any passenger other than the control right holder or not, upon acquisition of the renunciation request from the control right holder, and
makes the control right holder remain holding the control right and switches a display screen on a display installed for a seat in which the control right holder sits, from a display screen for the control right holder to another display screen, in case where t the transfer request has not been acquired from any passenger other than the control right holder upon the acquisition of the renunciation request from the control right holder.

16. The on-board device according to claim 11, wherein
a display is installed for each of a plurality of seats included in the vehicle, and
the processing circuitry switches a display screen, displayed on the display installed for a seat in which the transfer requester sits, into a display screen for a control right holder, upon decision that the control right is to be transferred to the transfer requester.

17. The on-board device according to claim 11, wherein
the processing circuitry determines presence or absence of the driving qualification of each of the passengers, before the vehicle starts to travel, and warns that the vehicle is prohibited from traveling in case where any of the passengers does not have the driving qualification.

18. A control right management method comprising:
acquiring, by a computer installed on a vehicle in which an automated driving system is installed, the vehicle including a plurality of seats for each of which a display is installed, a transfer request requesting transfer of a control right that is a right to control the automated driving system, from any passenger among a plurality of passengers riding in the vehicle;
determining, by the computer, presence or absence of a driving qualification of a transfer requester who is the requesting passenger of the transfer request and deciding whether the control right is to be transferred to the transfer requester or not, based on the presence or absence of the driving qualification of the transfer requester; and
varying a layout of a display screen for a control right holder to be displayed on a display of a seat in which the control right holder sits, the control right holder being a passenger currently holding the control right, in accordance with which passenger among the plurality of passengers is the control right holder and which seat among the plurality of seats is the seat in which the control right holder sits.

19. A non-transitory computer readable medium storing a control right management program that causes a computer, installed on a vehicle in which an automated driving system is installed, the vehicle including a plurality of seats for each of which a display is installed, to execute:
a request acquisition process of acquiring a transfer request requesting transfer of a control right that is a right to control the automated driving system, from any passenger among a plurality of passengers riding in the vehicle;
a control right management process of determining presence or absence of a driving qualification of a transfer requester who is the requesting passenger of the transfer request and deciding whether the control right is to be transferred to the transfer requester or not, based on the presence or absence of the driving qualification of the transfer requester; and
a display screen layout control process of varying a layout of a display screen for a control right holder to be displayed on a display of a seat in which the control right holder sits, the control right holder being a passenger currently holding the control right, in accordance with which passenger among the plurality of passengers is the control right holder and which seat among the plurality of seats is the seat in which the control right holder sits.
